(19) United States
(12) Patent Application Publication
(10) Pub. No.: US 2006/0129595 A1
(43) Pub. Date: Jun. 15, 2006

(54) Method for analyzing and ranking data ranges in an n-dimensional space

(76) Inventor: Zhimin Chen, Aurora (CA)

Correspondence Address: Zhimin CHEN, 52 OSTICK STREET, AURORA, ON, L4G 7K5, CA

(21) Appl. No.: 11/284,946

(22) Filed: Nov. 23, 2005

(30) Foreign Application Priority Data
Nov. 24, 2004 (CA) 2,485,814

(51) Int. Cl. G06F 17/00

(52) U.S. Cl. 707/102

(57) ABSTRACT

A method and computer-readable medium for analyzing a set of two or more data ranges comprising the steps of selecting a first data range from the set, selecting at least one additional data range from the set, analyzing the relationship between the first data range and the at least one additional data range and ranking the first data range and at least one additional data range. In one aspect of the invention, a representative data range and an optimal data point are generated based on the ranking of the first data range and the at least one additional data range.

### CROSS REFERENCE TO RELATED APPLICATION

Canada patent application No. 2,485,814 filed on Nov. 24, 2004.

### FIELD OF THE INVENTION

The present invention relates to a method for analyzing a set of data ranges, and is more particularly concerned with a computer-based method of assigning ranks to determine the relationships between the one or more data ranges with a set and to identify an optimal data point within the set.

### BACKGROUND OF THE INVENTION

Businesses rely upon consumer surveys and questionnaires to assess the level of interest and demand for the products and services that they offer. The data obtained from surveys and questionnaires often provide valuable insights into a consumer's preferences which enable the business, such as a retailer or vendor, to efficiently manage their marketing campaigns, inventory levels and prices in order to maximize profitably.

Generally, the reliability of the survey and questionnaire results depend upon the manner by which the preference data was gathered and specificity of the responses received from the consumers. Consumers are often given simple yes or no or rating style (e.g. rank product between 1 to 5) questions which generate unhelpful responses. Conversely, other survey questions enable consumers to specify a range of data values that best match their preferences (e.g. between $10.00 and $20.00). Consumer preference data may also comprise of multiple dimensions, such as price, colour, quantity and quality, for example, which may be interrelated across several dimensions. Given the wide variety of data that is gathered from consumer surveys and questionnaires, the process of analyzing the consumer preference data can be a complex and time consuming endeavor.

Historically, methods and systems for determining the prevailing consumer preferences for products and services are unable to analyze data ranges across multiple dimensions. Rather, existing database-based ranking methods are adapted to merely rank the preferences of consumers along a single dimension, such as price. Moreover, computer-based spreadsheet programs are incapable of handling the voluminous number of calculations that are often required to analyze data ranges across multiple dimensions. As a result, the outcome of traditional methods and systems for analyzing consumer preference data often provide very little insight into the multitude of factors which may be influencing a consumer's buying behaviour. To a limited extent, “best-fit” type analyzes are capable of identifying trends in consumer preference data ranges. However, as with spreadsheet based methods, the best-fit results rarely provide the vendor with a specific data range or optimal value that they then may use to improve profitability or productivity, for example, of their business.

Accordingly, there is a need for a method for analyzing and ranking the relationships between data ranges in a set across multiple dimensions. Moreover, there is a need for a method of analyzing and ranking the data ranges across multiple dimensions to generate a representative data range and an optimal data point within the set.

### SUMMARY OF THE INVENTION

The present invention relates to is directed to a method for analyzing a set of data ranges, and is more particularly concerned with a computer-based method of assigning ranks to determine the relationships between the one or more data ranges with a set and to identify an optimal data point within the set.

In one aspect of the present invention, there is provided a method for analyzing a set of two or more data ranges comprising the steps of selecting a first data range from the set, selecting at least one additional data range from the set, analyzing the relationship between the first data range and the at least one additional data range, and ranking the first data range and the at least one additional data range within the set. The method may comprise the step of generating a representative data range based on the ranking of the first data range and the at least one additional data range. The representative data range may be an overlapping data range determined from the relationship between the first data range and the at least one additional data range. The method may also comprise the step of generating an optimal data point based on the ranking of the first data range and the at least one additional data range.

In another aspect of the method, the step of analyzing the relationship between the first data range and the at least one additional data range may comprises the sub-step of determining the probability of the first data range overlapping with the at least one additional data range. The method of analyzing the relationship between the first data range and the at least one additional data range may comprise the sub-step of analyzing the first data range and the at least one additional data range in one or more dimensions. A weighting constant may be generated for each of the one or more dimensions, wherein the weighting constant indicates the popularity of the one or more dimensions within the set. The weighting constant may be generated for each of the one or more dimensions to adjust the ranking of the first data range and the at least one additional data range.

The set may comprise of a first data range, at least one additional data range, and one or more overlapping data ranges. The first data range and the at least one additional data range include at least one dimension and one or more data values. A default value may be applied to the two or more data ranges having infinite data values, said default value representing an upper bound in said two or more data ranges. The default value may be applied to the two or more data ranges having infinite data values, wherein the default value represent a lower bound in the two or more data ranges.

In another aspect of the method of the present invention, the steps selecting at least one additional data range from said set, analyzing the relationship between said first data range and said at least one additional data range, and ranking said first data range and said at least one additional data range may be performed iteratively.

In another aspect of the method of the present invention, an initial rank may be assigned to each of each of the first data range and at least one additional data range. The initial rank may be updated based on the analysis of the relationship between the first data range and the at least one additional data range.

In another aspect of the method of present invention, two or more data ranges in a set may be analyzed by selecting one or more random data points within the set, analyzing the relationship between the one or more random data points and the two or more data ranges, wherein the two or more data ranges comprise a first data range and at least one additional data range within the set, and ranking the one or more random data points based on the relationship with the first data range and the at least one additional data range within the set. The one or more random data points may estimate a representative data range within the set. The one or more random data points estimate an optimal data point with the set. The one or more random data points may be assigned an initial rank. The initial rank is updated based on the analysis of the relationship between the one or more random data points and the first data range and the at least one additional data range within the set.

In another aspect of the present invention, a computer-readable medium encoding a computer program of instructions for executing a computer process for analyzing a set of two or more data ranges is described as comprising selecting a first data range from the set, selecting at least one additional data range from the set, analyzing the relationship between the first data range and the at least one additional data range, and ranking the first data range and the at least one additional data range within the set. The computer process may include generating a representative data range based on the ranking of the first data range and the at least one additional data range.

The representative data range may be an overlapping data range determined from the relationship between the first data range and the at least one additional data range. In another aspect of the present invention, the process of the computer-readable medium may comprise generating an optimal data point based on the ranking of the first data range and the at least one additional data range. The computer process of the computer-readable medium may be performed iteratively. A weighting constant for each of the one or more dimensions may be utilized to adjust the ranking of the first data range and at least one additional data range. The first data range and at least one additional data range may be assigned an initial rank. The first data range and at least one additional data range may include at least one dimension and one or more data values.

In another aspect of the present invention, a computer-readable medium encoding a computer program of instructions for executing a computer process for analyzing a set of two or more data ranges describes the computer process of selecting one or more random data points with the set, analyzing the relationship between the one or more random data points and the two or more data ranges, wherein the two or more data ranges comprise a first data range and at least one additional data range within, and ranking the one or more random data points based on the relationship with the first data range and the at least one additional data range within the set.

### BRIEF DESCRIPTION OF THE DRAWINGS

For a better understanding of the present invention, and to show more clearly how it may be carried into effect, reference will now be made, by way of example, to the accompanying drawings in which:

FIG. 1 is a graphical representation of the relationship between data range C and data range D;

FIG. 2 is a graphical representation of the relationship between data ranges A, B and C;

FIG. 3 is a flowchart illustrating the steps in a method of analyzing two or more data ranges within a set in an embodiment of the present invention;

FIG. 4 is a table containing a first data range and at least one additional data range in an example of an embodiment of the present invention;

FIG. 5 is a table containing an initial rank assigned to each of the first data range and at least one additional data range in FIG. 4 in an embodiment of the present invention;

FIG. 6 is a graphical representation of the relationship between the first data range and at least one additional data range in FIG. 4 in the example of an embodiment of the present invention;

FIG. 7 is a table containing the ranks of the data ranges in FIG. 4 based on the relationship between RANGE_1 and RANGE_2 in the example of an embodiment of the present invention;

FIG. 8 is a graphical representation of the relationship between RANGE_1 and RANGE_2 in the example of an embodiment of the present invention;

FIG. 9 is a graphical representation of the relationship between RANGE_1, RANGE_2, RANGE_3 and RANGE_5 in the example of an embodiment of the present invention;

FIG. 10 is a table containing the ranks of the data ranges based on the relationship between RANGE_1, RANGE_2, RANGE_3 and RANGE_5 in the example of an embodiment of the present invention;

FIG. 11 is graphical representation of the relationship between RANGE_1, RANGE_2, RANGE_3, RANGE_4 and RANGE_5 in the example of an embodiment of the present invention; and

FIG. 12 is a table containing the ranks of the data ranges based on the relationship between RANGE_1, RANGE_2, RANGE_3, RANGE_4 and RANGE_5 in the example of an embodiment of the present invention.

### DETAILED DESCRIPTION OF THE INVENTION

The present invention relates to a method of analyzing and ranking a set of data ranges, and is more particularly concerned with a computer-based method of analyzing and assigning ranks to data ranges within a set to determine the relationships between each of the data ranges within the set and to identify an optimal data point within the set.

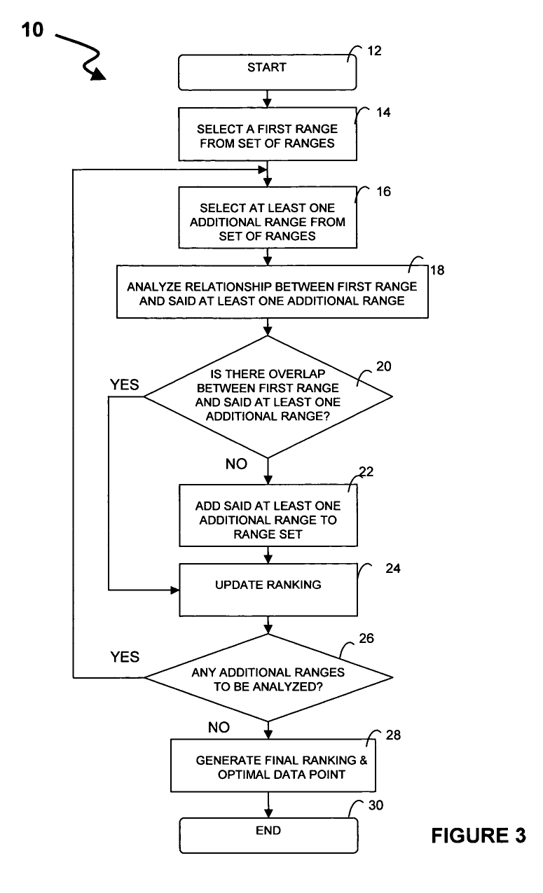

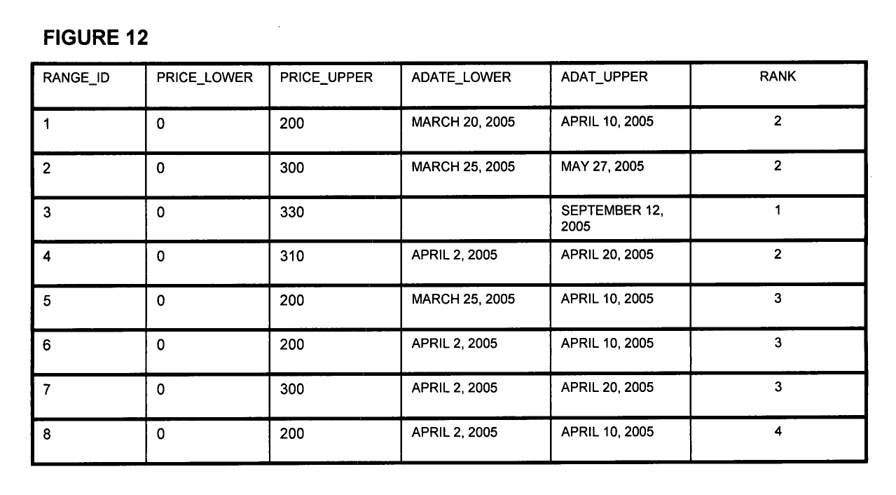

The present invention provides for the ranking of a first data range against each of the remaining at least one additional data ranges within a set, S. The ranking of the first data range and at least one additional data range is based one the relationship between the data ranges within the set, S. Once the relationships between the data ranges has been determined, the present invention then provides for the determination of a representative data range which best represents the data ranges contained within the entire set, S. The present invention is then adapted to determine the optimal data point within the representative data range. As will be discussed in greater detail with reference to FIGS. 3-12, the optimal data point may represent the most profitable price or availability date for a product or service offered by a vendor to one or more consumers, for example.

In the specification and in the claims, reference to will be made to the terms set, range set, data range, data value and data point. For ease of understanding, a set is a collection of data which defines a space having an upper limit and a lower limit. The data comprising the set may consist of one or more data ranges and/or one or more data points. Data ranges may consist of a unary value and a binary value, wherein the unary value represents the lower bound of said data range and the binary value represents the upper bound of said data range. The specification of the data range is defined as the distance between the lower bound and the upper bound. A data range may consist of finite data values, such as, for example, the integer data range specification 3 to 5 consisting of the finite data values 3, 4, and 5. Moreover, a data range may also consist of infinite data values, such as zero to infinite. A data point may also be defined as a range having upper and lower bounds that are equal. It should be understood that the terms set, range set, data range, data value and data point may also have any meaning that is commonly used by persons skilled in the art.

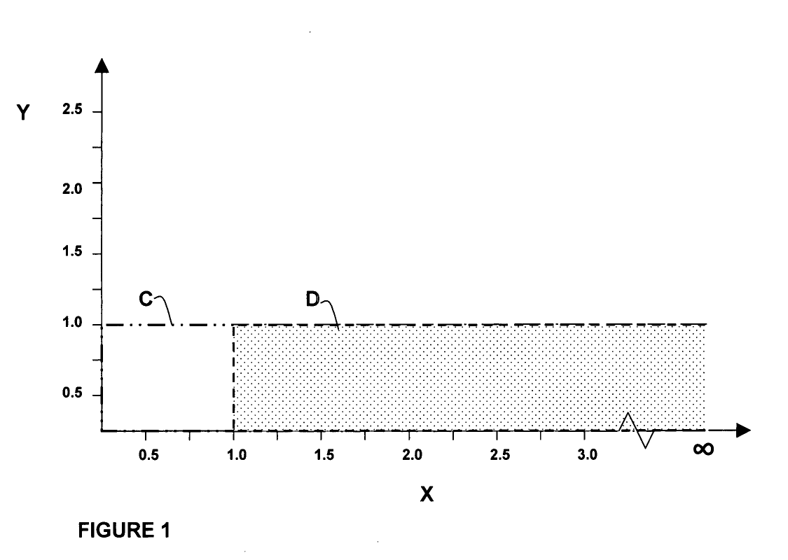

In a linear (e.g. one dimension) space, a data range, A, may have a specification defined as A{(x)|0<x<10}. A data point x=1 would represent a data value within the range A. In a two dimensional space, a set may include a two data ranges C and D. Range C may be defined as C{(x, y)|x>0; 0<y<1}. Range D may be defined as D{(x, y)|x>1}. Reference is made to FIG. 1 which illustrates the intersecting or overlapping relationship between the data ranges C and D (shown as a shaded area). Within any given set, the relationship between data ranges C and D may be intersecting (or overlapping) or non-intersecting, for example.

In a set consisting of two or more data ranges, it is possible that one data range may entirely intersect or overlap with the other data range. When this occurs, the data range that is contained entirely within the other data range is defined as a sub-set. Similarly, where both data ranges in a set have equal upper and lower bounds in all dimensions, the data ranges are described as being “equal” data ranges. In the case of “equal” data ranges, each of the data ranges may be defined as being a sub-set of the other.

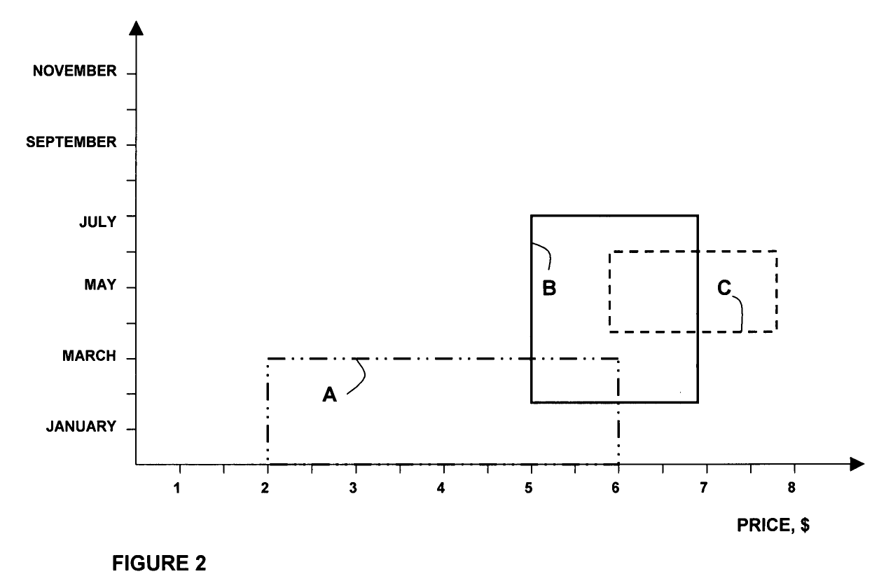

Reference is made to FIG. 2 which illustrates the relationship between three data range A, B and C in a two dimensional sample set, S_{abc}. The specification of the data ranges are defined as A{(x, y)|2≦x≦6; 1≦y≦3}, B{(x, y)|5≦x≦7; 2≦y≦7}, and C{(x, y)|6≦x≦8; 4 5y≦6}. Data range A intersects with data range B, but not data range C. Data range B intersects with both data ranges A and C. Data range C does not intersect with data range A, but does intersect with data range B.

An embodiment of a method of analyzing and ranking a set comprising a first data range and at least one additional data range to determine a representative data range and to identify an optimal data point within said set is described below with reference to FIG. 3. Referring to FIG. 3, the steps in an embodiment of the present invention for analyzing and ranking the relationship between each of a first data range and at least one additional data range are shown generally as 10, and commence at step 12. At step 14, user (such as a vendor, for example) selects a first data range from a set of two or more data ranges. At step 16, user is instructed to select at least one additional data range from the set of data ranges at step 14. It should be understood that the method of the present invention may be performed on computer-based system, and the selection of the first data range and at least one additional data range in step 14 and 16 may be an automatic and iterative process. The method proceeds to step 18, where the relationship between the first data range and at least one additional data range is analyzed and ranked.

The relationship between the first data range and at least one additional data range in a set, S, at step 16, in the n-dimension may be defined as:

$$r ( A , S ) = {\sum }_{i = 1}^{k} {β}_{i} ( {\prod }_{j = 1}^{k} {( \vert {A}_{j} ⋂ {R}_{ij} \vert / \vert {A}_{j} \vert )}^{1 / {α}_{j}} ) \qquad [ 1 ]$$

where S is a set of data ranges and A is the specification of the first data range in the set, S. Rij is the specification of the at least one additional data range in the set, S, which is being analyzed with the first data range. The i-th dimension may consist of a number, k, of data ranges in the set, S. The number of dimensions of data ranges in the i-th dimension may be defined as i ε [1, k]. Similarly, n is the number of dimensions of data ranges in the j-th dimension in the set, S, and may be described as j ε [1, n]. The rank r(A,S) of each of the first data range and at least one additional data ranges in set, S, is an indication of the popularity or importance of the each of the data ranges within the set, S. Moreover, the rank of each of the data ranges provides an indication of the degree to which the subject data range is representative of the entire set, S.

60 is a pre-defined dimension weighting constant to reflect the greater popularity or higher ranking of data ranges in a particular dimension as compared to other dimensions in the set, S. However, the data ranges may intersect or overlap in another dimensions (such as, for example, the i-th dimension). When a particular dimension has a stronger influence on the overall ranking, r, of data ranges within the set, S, the dimension weighting constant α will be larger. Conversely, as the value of α decrease, the popularity or ranking, r, of data ranges in the particular dimension will approach zero. For example, when αⱼ=0, the ranking of data ranges in the j-th dimension will be equal to zero, as follows:
(|Aⱼ ∩ Rᵢⱼ |/|Aⱼ |)^{1/α}_{ⱼ}=0 [2]

In this example, the lower popularity or ranking of data ranges in the j-th dimension may be a result of the fact that these data ranges do not overlap or intersect with remaining data ranges in the set, S. If data ranges in the j-th dimension are determined to be of low importance in the ranking of the remaining data ranges in the set, S, the value of αⱼ may be set equal to zero. In doing so, data ranges in the j-th dimension, for example, will not be considered when ranking the data ranges within the set, S.

Returning to Equation [1], importance factor β may be set uniformly for all data ranges. Alternatively, β may be a special factor applied to only certain data ranges to indicate the relative importance of these data ranges in the set, S. For example, β may be a representation of the importance to a vendor of a first company's preferences over a second company's preferences. If the first company has 10,000 employees who will each require a product or service from the vendor, the resulting weighting factor β for this company's data ranges may be higher than the weighting factor β for a second company having only 10 employees. The importance of the second company's preferences may increase if its data ranges intersect or overlap with those of the first company. This is due to the fact that a portion of the preferences of the second company are identical, for example, to the preferences of the first company. It should be understood that β may be any suitable weighting factor known by a person skilled in the art, including, but not limited to, historical sales data, demographics, distance, quantity, availability and quantity of preference data received.

|Aⱼ ∩Rᵢⱼ |/|Aⱼ | in Equation [1] denotes the probability of a data value or data point in the first data range Aⱼ occurring in or belonging to at least one additional data range Rᵢⱼ in the j-th dimension. A data value or data point in the first data range Aj will occur or belong to the at least one additional data range Rᵢⱼ if the data ranges intersect or overlap with each other across all dimensions. The probability of the first data range Aⱼ intersecting or overlapping with the at least one additional data range within a particular dimension may be determined using the dimension weighting factor as denoted below:
(|Aⱼ ∩ Rᵢⱼ |/|Aⱼ |)^{1/α}_{ⱼ} [3]

In an alternate embodiment of the present invention, the relationship between the first data range, A, and at least one additional data range, R, in a set, S, may be defined as:

$$r ( A , S ) = {\sum }_{i = 1}^{k} {β}_{i} ( {\sum }_{j = 1}^{n} ( 1 / {α}_{j} ) log ( \vert {A}_{j} ⋂ {R}_{ij} \vert / \vert {A}_{j} \vert ) ) \qquad [ 4 ]$$

It should be understood that the first data range or at least one additional data range may not be the representative data range of the set, S. Rather, the representative data range may be defined by the overlapping or intersecting portions of the first data range and/or at least one additional data range.

Moreover, when a data range A is a subset of another data range within the set, S, the rank assigned to the data range A according Equation [1] is “1”. The relationship where data range A is a subset of data range Rᵢ (e.g. Rᵢ εS) may be defined as:

$${\prod }_{j = 1}^{n} {( \vert {A}_{j} ⋂ {R}_{ij} \vert / \vert {A}_{j} \vert )}^{1 / {α}_{j}} = 1 \qquad [ 5 ]$$

Therefore, if data range A is a subset of all data ranges in the set, S, the rank for A is defined as:

$$r ( A , S ) = {\sum }_{i = 1}^{k} {β}_{i} \qquad [ 6 ]$$

In a non-uniformly weighted set, S, the rank is the sum of the importance factor β for each of the first data range and at least one additional data range. In a uniformly weighted set, S, the rank is the product of the uniform importance factor β and the number of ranges k.

It is possible that user of the method of the present invention may only input data range specifications in some dimensions, and leave the remaining dimensions unspecified. The incompleteness of the user specified data ranges may result in difficulties in the calculation of the ranks because the extent of the bounds of the unspecified dimension would be infinite (e.g. ∞). When the specification of a data range is infinite, the rank assigned or generated for the data range would equal zero. Although assigning or generating a zero rank for an infinite data range may be the correct determination, it prevents a meaningful comparison between the first data range and at least one additional data range in the set, S. Accordingly, in an alternative embodiment of the present invention, the method may be adapted to apply a default value ε to data ranges having infinite upper and/or lower bounds (e.g. data values), such that:
ε, if |Aⱼ∩Rᵢⱼ|≠0 and |Aⱼ|→∞
otherwise:
|Aⱼ ∩ Rᵢⱼ |/|Aⱼ |=51 Aⱼ ∩ Rᵢⱼ |/|Aⱼ [7]

In a preferred embodiment of the invention, default boundaries may be introduced for each of the dimensions within the set, S, such that the relationships between the first data range and at least one additional data range may be determined in a bounded space. By this design, each of the first data range and at least one additional data range will factor into the ranking of the data ranges and the determination of the representative data range and/or optimal data point.

Returning to FIG. 3, if the first data range and at least one data range are determined to overlap or intersect at step 20, the range specification of the overlapping portion of the first data range and at least one additional data range may be determined at step 22. The range specification of the overlapping portion of the first data range and at least one additional data range may then be included in the set, S, at step 22 for use when analyzing the remaining data ranges in the set, S. If the overlapping data range already exists in the set, S, the corresponding range specification for the overlapping portion may not be included in the set, S. When an overlapping range is included into or deleted from the original set, the rank for each of data ranges may be updated to reflect the relationships between the data ranges within the revised set, S, without requiring a re-determination the ranks of the data ranges within the entire set, S.

The ranks for each of the first data range and/or the at least one additional data ranges and/or the range specifications of the overlapping data ranges may be stored in a database or suitable storage means at step 24.

The method proceeds to step 26 to determine whether any additional data ranges remain to be analyzed in the set, S. If, at step 26, additional data ranges in the set, S, remain to be analyzed and ranked, the method of the present invention proceeds to step 16. At least one additional data range is selected at step 16 for subsequent analysis and ranking against the first data range and the set, S, at step 18. The analysis and ranking of the data ranges within a set, S, is an iterative process which determines the relationship between a first data range and at least one additional data range. The set, S, may include the specifications for the overlapping range data determined in previous iterations of the method. For example, a set, S, may comprise twenty (20) data ranges. In order to determine the popularity or rank of the first data range in the set, S, it would be necessary determine the relationship of the first data range with each of the additional data ranges through nineteen iterations of Equation [1] or any of the variants of this equation herein. The sum of the probabilities associated with each iteration through Equation [1] represents the popularity or rank of the first data range in the set, S. The popularity or rank may also be interpreted as the total acceptance of the first data range by all ranges within the set, S. The popularity or rank of a second data range, for example, in the set, S, would then be determined in a similar manner.

If, at step 26, no additional data ranges in the set, S, remain to be analyzed and ranked, the method proceeds to step 28. At step 28, the specification of the representative data range and the optimal data point within the set, S, are determined. The method of the present invention then ends at step 30.

In a variant embodiment of the present invention, one or more random data points within the set, S, may be selected to estimate of the representative data range and/or the optimal data point. By this design, a vendor may select a random data point within the set, S, wherein the random data point represents a pending offer (e.g. price) of a product or service by the vendor to the consumers. The selection of the one or more random data points may be based on historical data or policies developed by the vendor or related businesses in the industry, for example. The vendor may then determine whether the random data point is a data value within the representative data range or is the optimal data range. If the random data point (e.g. offer) is a data value in the representative data range, the offer of the product or service to consumers will likely be profitable to the vendor. If the random data point is not a data value in the representative data range, the vendor will know that more profitable offers for the products and/or service may be generated. The vendor may then wish to select a further random data point to estimate the representative data range and/or optimal data point.

In a further aspect of the variant embodiment of the present invention, the one or more random data points selected by the vendor may be analyzed and ranked against the set, S, of two or more data ranges to determine whether the one or more random data points are data values within the representative data range or are the optimal data point. Several iterations of the analysis and ranking of the one or more random data points may be performed until at least one of the selected one or more random data points is determined to represent the set, S, representative data range and/or the optimal data point. As with the analysis and ranking of the data ranges, the rank assigned to the one or more random data points may be updated to reflect the rank assigned to the one or more random data points in subsequent iterations of the method.

In a variant embodiment of the present invention, ranks associated with each of the first data range and the least one additional data range may be determined for each of the dimensions simultaneously. By this design, it will be possible to process the data ranges and identify the representative data ranges and/or optimal data point with fewer iterations.

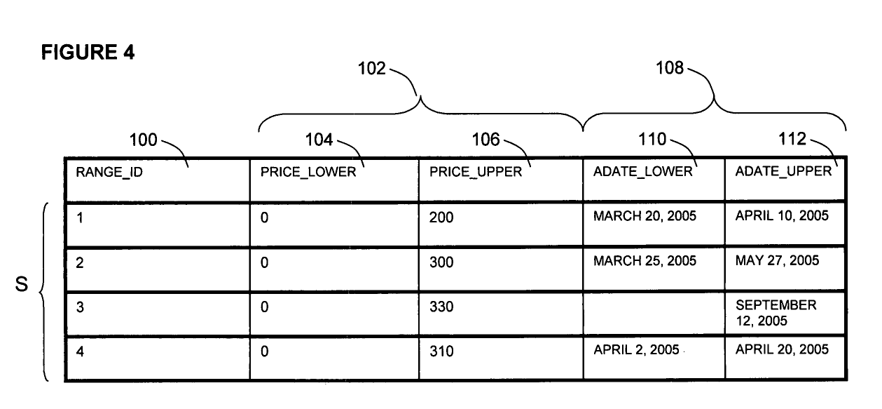

An illustrative example of the method of the present invention in the context of a vendor offering of one or more products and services to consumers will be described with reference to FIGS. 3-12. In FIG. 4, RANGE_ID (shown as numeral 100) indicates that number of data ranges to be analyzed and ranked using the method of the present invention, namely RANGE_1, RANGE_2, RANGE_3 and RANGE_4. Each of the four data ranges 100 relate to the purchasing preferences of consumers in respect to the products and services offered by the vendor. In this example, the data ranges of consumer preferences are two dimensional. The first dimension of the consumer preference data ranges is PRICE, shown as generally as numeral 102. Data ranges in the PRICE dimension comprise a lower price bound 104 (e.g. PRICE_LOWER) and an upper price bound 106 (e.g. UPPER_PRICE). The second dimension of the consumer preference data ranges in this illustrative example is time or ADATE, shown generally as numeral 108. Data ranges in the ADATE dimension comprise a lower time bound 110 (e.g. ADATE_LOWER) and an upper time bound 112 (e.g. ADATE_UPPER). The consumer preference range data associated with RANGE_1 indicates that a first consumer would be willing to purchase the products and services between Mar. 20 and Apr. 10, 2005, if the price were less than $200.00. Similarly, RANGE_2 indicates that a second consumer would purchase the products and services between Mar. 25 and May 27, 2005, if the price were less than $300.00. RANGE_3 shows that a third consumer would purchase the products and services any time prior to Sep. 12, 2005, if the price were less than $330.00. Lastly, RANGE_4 indicates that a fourth consumer would purchase the products and services during the period from Apr. 2 to Mar. 20, 2005 if the price were less than $310.00. Collectively, RANGE_1, RANGE_2, RANGE_3 and RANGE_4 represent the set, S.

The set of data ranges in FIG. 3 may also be defined as follows:
RANGE_1:
{(PRICE, ADATE)| PRICE≦$200.00; Mar. 20, 2005≦ADATE≦Apr. 10, 2005}
RANGE_2:
{(PRICE, ADATE)| PRICE≦$300.00; Mar. 25, 2005≦ADATE≦May 27, 2005}
RANGE_3:
{(PRICE, ADATE)| PRICE≦$330.00; ADATE≦Sep. 12, 2005}
RANGE_4:
{(PRICE, ADATE)| PRICE≦$310.00; Apr. 2, 2005≦ADATE≦Mar. 20, 2005}

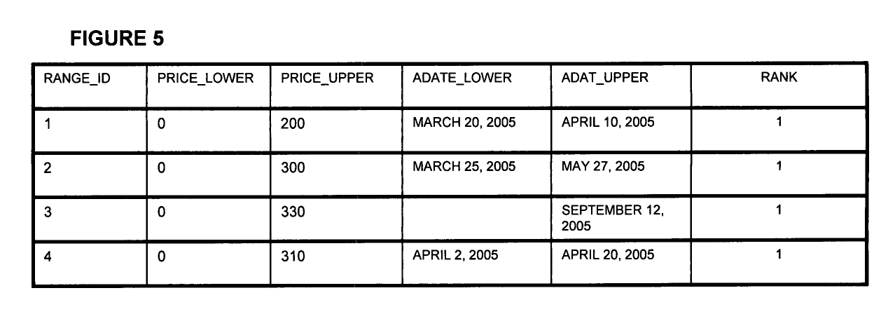

As shown in FIG. 5, each of the data ranges (e.g. RANGE_1 to RANGE_4) in the set, S, are initially assigned a RANK of “1” (shown as numeral 114).

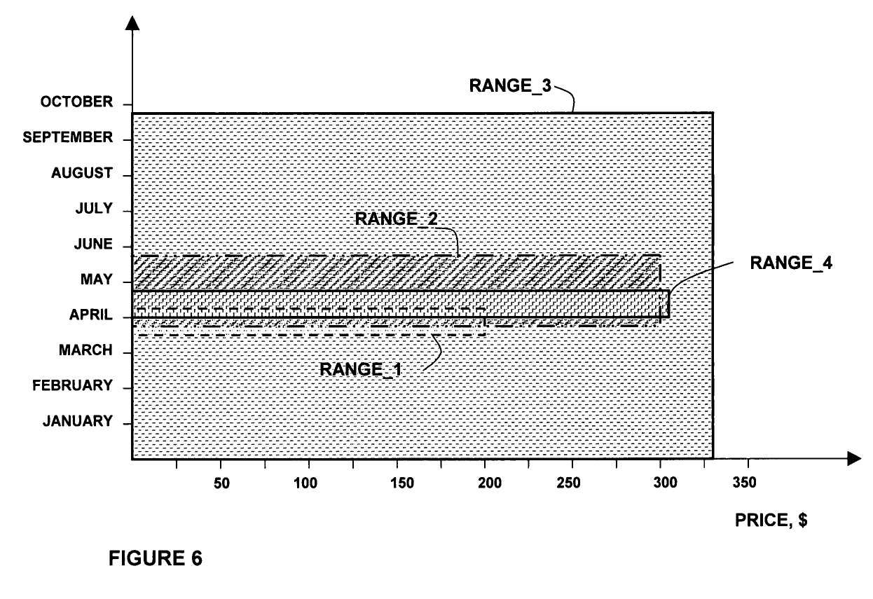

Reference is made to FIG. 6 which illustrates the relationship between the set of data ranges RANGE_1, RANGE_2, RANGE_3 and RANGE_4. Within the set, RANGE_1 intersects or overlaps with each of the remaining data ranges, RANGE_2, RANGE_3 and RANGE_4. Similarly, RANGE_2 intersects or overlaps with data ranges RANGE_1, RANGE_3 and RANGE_4. RANGE_3 intersects with RANGE_1, RANGE_2 and RANGE_4. And, lastly, RANGE_4 overlaps with RANGE_1, RANGE_2 and RANGE_3.

Referring to FIG. 3, RANGE_1 is selected as the first data range from the set of data ranges at step 14. RANGE_2 is then selected at step 16 to represent the at least one additional range. It should be understood that any of the data ranges within the set may be selected as the first data range and the at least one additional range in order to commence the steps of the method of the present invention.

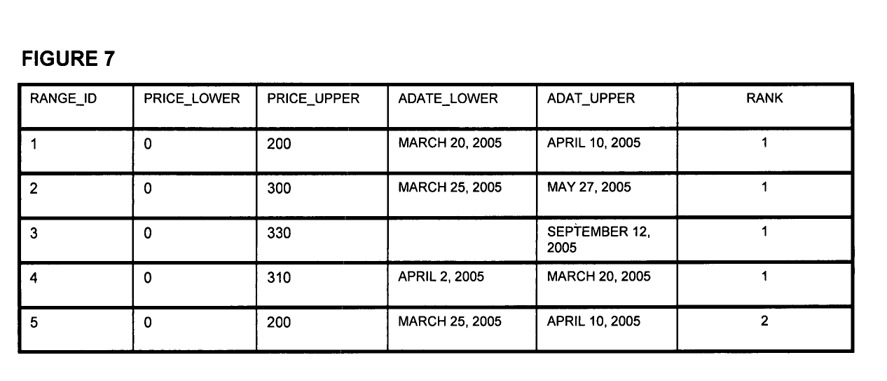

At step 18, the relationship between RANGE_1 and RANGE_2 may be analyzed and ranked using Equation 1 in each of the two dimensions PRICE and ADATE. RANGE_1 and RANGE_2 may be first analyzed and ranked in the ADATE dimension to determine the degree to which the data ranges have an intersecting relationship. As more clearly shown in FIG. 7, RANGE_1 and RANGE_2 intersect in the ADATE dimension to form a new data range RANGE_5. RANGE_5 is a subset of both RANGE_1 and RANGE_2 having lower and upper bounds in the ADATE dimension of ‘Mar. 25, 2005’ and ‘Apr. 10, 2005’, respectively. RANGE_1 and RANGE_2 are then analyzed and ranked to determine whether the data ranges intersect in the PRICE dimension. As shown in FIG. 7, RANGE_1 and RANGE_2 intersect in the PRICE dimension from a lower bound price of $0.00 to an upper bound price of $200.00. Accordingly, the specification for RANGE_5 may be defined as:
RANGE_5:
{(PRICE, ADATE)| PRICE≦$200.00; Mar. 25, 2005≦ADATE≦Apr. 10, 2005}

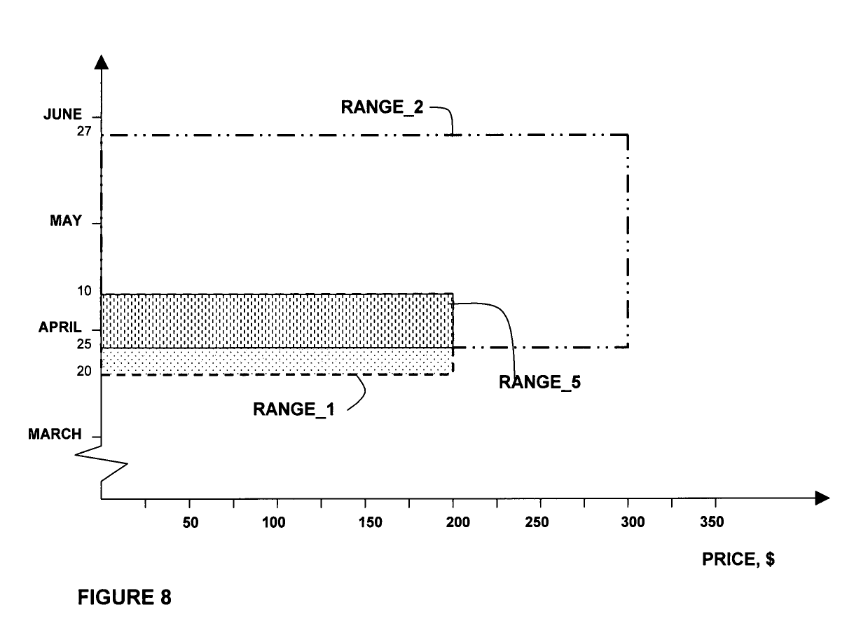

The method at step 20 of FIG. 3 proceeds to step 24 since RANGE_1 and RANGE_2 intersect to form subset RANGE_5. The updated ranking of the RANGE_1 to RANGE_4 and RANGE_5 are shown in FIG. 8. The rank assigned to RANGE_5 is the sum of the initial ranks of RANGE_1 and RANGE_2 (e.g. 1+1=2). Thus, the rank assigned to the data range RANGE_5 will be “2”. When analyzing and ranking the remaining data ranges, RANGE_5 is preferably included as an additional data range in the set, S.

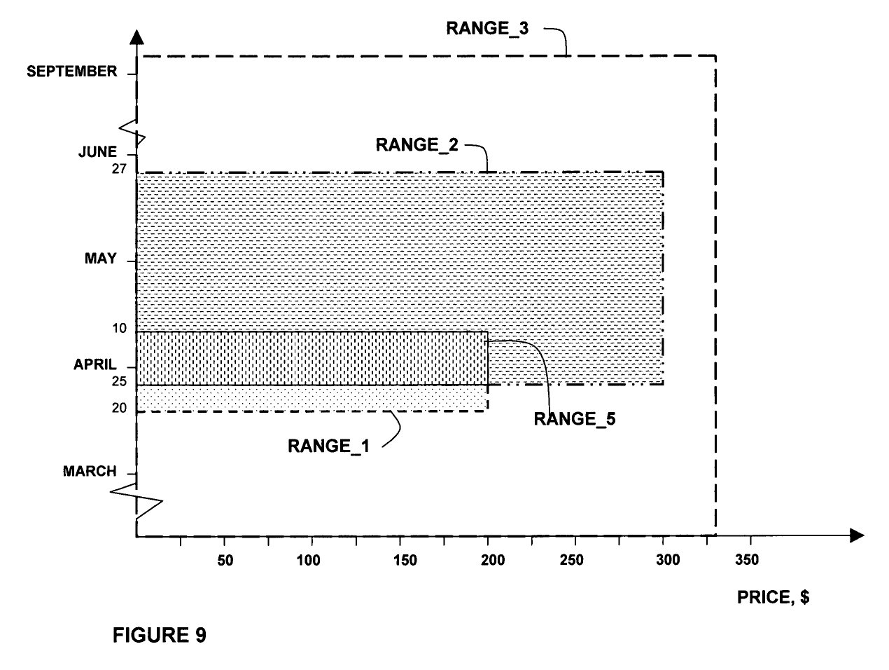

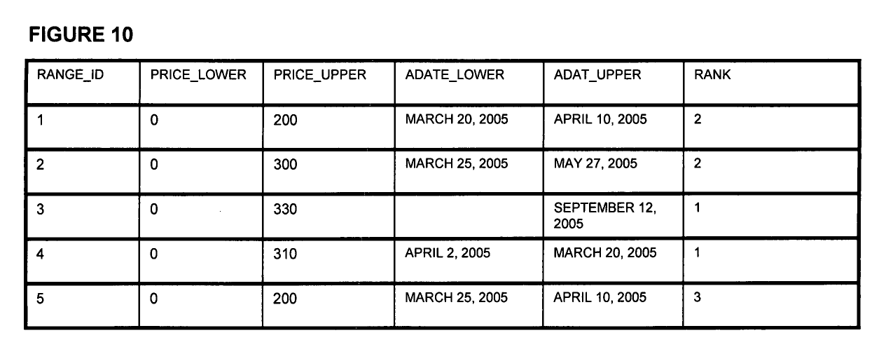

If there is at least one additional data range to be analyzed in the set, S, at step 26, the method proceeds to step 16 where at least one additional data range is selected to be analyzed and ranked. Continuing the illustrative example, the relationship between RANGE_3 and the previously analyzed ranges RANGE_1, RANGE_2 and RANGE_5 is analyzed. The relationship between RANGE_1, RANGE_2, RANGE_3 and RANGE_5 is shown in FIG. 9. Since RANGE_1, RANGE_2 and RANGE_5 are all subsets of RANGE_3, the rank of RANGE_3 will remained unchanged. However, the ranks of RANGE_1, RANGE_2 and RANGE_5 will each increase by “1” since each of these data ranges is a subset of RANGE_3. As shown in the FIG. 10, the ranks of RANGE_1 and RANGE_2 have been increased to “2” (e.g. 1+1), and the rank of RANGE_5 has been increased to “3” (e.g. 2+1). The set of data ranges now preferably includes RANGE_1, RANGE_2, RANGE_3 and RANGE_5.

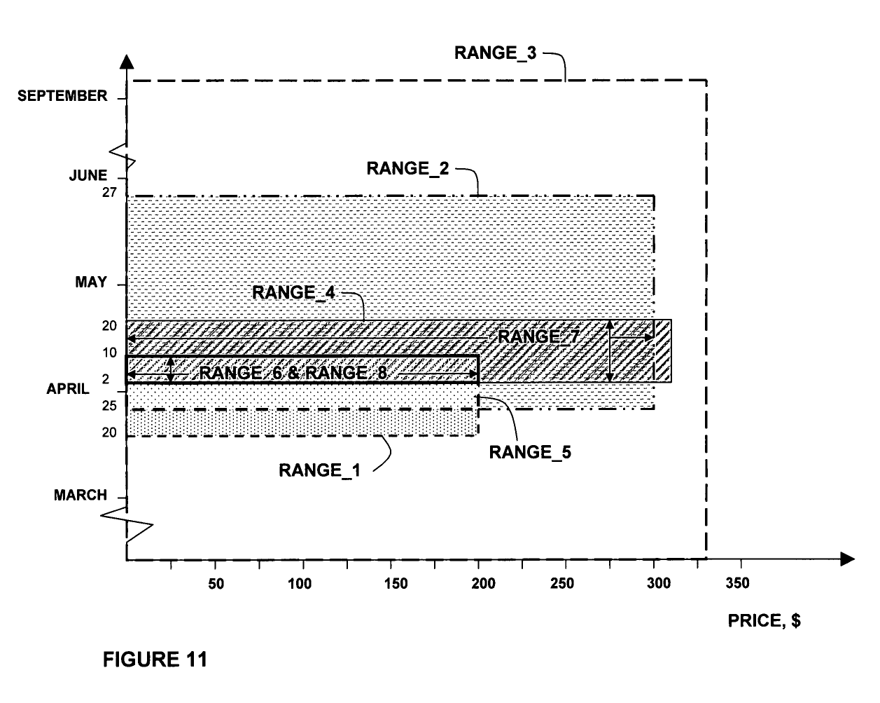

The method proceeds again to step 26, and then to step 16 to analyze and rank RANGE_4 in relation to the set, S, including RANGE_1, RANGE_2, RANGE_3 and RANGE_5. As is shown in FIG. 11, the inclusion of RANGE_4 in the set, S, generates new data ranges RANGE_6, RANGE_7 and RANGE_8. Specifically, the intersection of RANGE_1 and RANGE_4 generates RANGE_6. The intersection of RANGE_2 and RANGE_4 similarly generates RANGE_7, and the relationship between RANGE_4 and RANGE_5 generates RANGE_8. Accordingly, the range specifications of the new data ranges may be defined as follows:
RANGE_6:
{(PRICE, ADATE)| PRICE≦$200.00; Apr. 2, 2005≦ADATE≦Apr. 10, 2005}
RANGE_7:
{(PRICE, ADATE)| PRICE≦$300.00; Apr. 2, 2005≦ADATE≦Apr. 20, 2005}
RANGE_8:
{(PRICE, ADATE)| PRICE≦$200.00; Apr. 2, 2005≦ADATE≦Apr. 10, 2005}

The ranking of RANGE_4 is shown in FIG. 11. Since RANGE_4 is a subset of RANGE_3, the rank for RANGE_2 is increase from 1 to 2.

The rank assigned to RANGE_6 equals the sum of the initial ranks of RANGE_1 and RANGE_4 (e.g. 1+1=2), plus the initial rank of RANGE_3 (e.g. “1”), since RANGE_6 is a subset of RANGE_3. Accordingly, the rank for RANGE_6 is 3. Similarly, the rank assigned to RANGE_7 is “3”, based on the initial ranks of RANGE_2 and RANGE_4, and the fact that RANGE_7 is a subset of RANGE_3. Lastly, the rank assigned to RANGE_8 of “4” is generated by adding the initial rank of RANGE_4 (e.g. “1”), RANGE_5 (e.g. “3”) and RANGE_3 (e.g. “1”). In actual use, RANGE_6 may be deleted since both RANGE_8 and RANGE_6 have the same data range specification. RANGE_6 may be deleted instead of RANGE_8 because it has a lower rank.

If, at step 26 in FIG. 3, there are no additional data ranges to be analyzed and ranked, the method proceeds to step 28 to generate the specification of the representative data range and the optimal data point in the set, S. In the context of the illustrative example, the representative data range and optimal data point may represent the most profitable outcome for the vendor from offering the products and services to consumers. The most profitable representative data range may be determined by multiplying the rank of the each of the data ranges in the set (including the overlapping data ranges RANGE_5, RANGE_6, RANGE_7 and RANGE_8) by the gross profit associated with each respective data range, as follows:
PROFIT=[(Price associated with subject data range)−(Cost to provide product or service)]×(Rank associated with subject data range)

The representative data range will be the data range within the set, S, that results in the highest profit. Assuming that the cost of providing the product or service to the consumers is $140.00, the most profitable data range within the set, S, may be determined as follows:
RANGE_1: Profit₁=($200.00-$140.00)×2=$120.00
RANGE_2: Profit₂=($300.00-$140.00)×2=$160.00
RANGE_3: Profit₃=($330.00-$140.00)×1=$190.00
RANGE_4: Profit₄=($310.00-$140.00)×2=$340.00
RANGE_5: Profit₅=($200.00-$140.00)×3=$180.00
RANGE_6: Profit₆=($200.00-$140.00)×3=$180.00
RANGE_7: Profit₇=($300.00-$140.00)×3=$480.00
RANGE_8: Profit₈=($200.00-$140.00)×4=$240.00

Accordingly, the analysis and ranking results of the illustrative example of the present invention indicate RANGE_7 is the representative data range of the set, S. The most profitable PRICE and time for the vendor to offer the products and services to the consumers (e.g. optimal data point) is $300.00 between Apr. 2, 2005 and Apr. 20, 2005.

The steps to be performed in analyzing and ranking the data ranges in the set, S, are then completed at step 30. It will be obvious to those skilled in the art that difference stapes and/or additional steps may be performed to analyze and rank the first data range and at least one additional data range within the set, S, and determining the optimal data point without departing from the scope of the present invention.

It will be obvious to those skilled in the art that the method of the present invention should not be limited to numeric data ranges. Rather, the method of the present invention may be used to analysis and rank the relationships between various data ranges and data points. For example, a range set S_{ab} consists of ranges A and B comprising the finite elements or data values “ABCD” and “ABC”, respectively, may be analyzed and ranked using the method of the present invention such that the rank, r(A,S_{ab})=1 and r(B,S_{ab})=¾. In this case, the range sizes are reversed in the string sizes.

Furthermore, it will be obvious to those skilled in the art that the method of the present invention may be embodied in computer readable media to be used in programming a computer-based system or processing device to perform in steps described herein. The computer readable media may be provided with programming information to enable the performance of the steps of the present invention, and may include a floppy diskette, CD ROM, DVD ROM, flash memory or other removable readable medium. Programming information may include any expression, in any language, code or notation, or set of instructions intended to cause a system having an information processing capability to perform the method of the present invention.

While what has been shown and described herein constitutes a preferred embodiment of the subject invention, it should be understood that various modifications and adaptions of such embodiment can be made without departing from the present invention, the scope of which is defined in the appended claims.

1. A method for analyzing a set of two or more data ranges, said method comprising the steps of:
(a) selecting a first data range from said set;
(b) selecting at least one additional data range from said set;
(c) analyzing the relationship between said first data range and said at least one additional data range; and
(d) ranking said first data range and said at least one additional data range within said set.

2. The method according to claim 1, further comprising the step of generating a representative data range based on the ranking of said first data range and said at least one additional data range.

3. The method according to claim 2, wherein said representative data range is an overlapping data range determined from the relationship between said first data range and said at least one additional data range.

4. The method according to claim 1, further comprising the step of generating an optimal data point based on the ranking of said first data range and said at least one additional data range.

5. The method according to claim 1, wherein the step of analyzing the relationship between said first data range and said at least one additional data range, further comprises the sub-step of determining the probability of said first data range overlapping with said at least one additional data range.

6. The method according to claim 1, wherein the step of analyzing the relationship between said first data range and said at least one additional data range, further comprises the sub-step of analyzing said first data range and said at least one additional data range in one or more dimensions.

7. The method according to claim 6, wherein a weighting constant is generated for each of said one or more dimensions, wherein said weighting constant indicates the popularity of said one or more dimensions within said set.

8. The method according to claim 6, wherein a weighting constant is generated for each of said one or more dimensions to adjust the ranking of said first data range and said at least one additional data range.

9. The method according to claim 1, wherein said set comprises of said first data range, said at least one additional data range, and one or more overlapping data ranges.

10. The method according to claim 1, wherein said first data range and said at least one additional data range include at least one dimension and one or more data values.

11. The method according to claim 1, wherein a default value is applied to said two or more data ranges having infinite data values, said default value representing an upper bound in said two or more data ranges.

12. The method according to claim 1, wherein a default value is applied to said two or more data ranges having infinite data values, said default value represent a lower bound in said two or more data ranges

13. The method according to claim 1, wherein steps (b), (c) and (d) are performed iteratively.

14. The method according to claim 1, wherein each of said first data range and at least one additional data range are assigned an initial rank.

15. The method according to claim 1, wherein said initial rank is updated based on the analysis of the relationship between said first data range and said at least one additional data range.

16. A method for analyzing a set of two or more data ranges, said method comprising the steps of:
(a) selecting one or more random data points within said set;
(b) analyzing the relationship between said one or more random data points and said two or more data ranges, wherein said two or more data ranges comprise a first data range and at least one additional data range within;
and
(c) ranking said one or more random data points based on the relationship with said first data range and said at least one additional data range within said set.

17. The method according to claim 16, wherein said one or more random data points estimate a representative data range within said set.

18. The method according to claim 16, wherein said one or more random data points estimate an optimal data point with said set.

19. The method according to claim 16, wherein each of said one or more random data points is assigned an initial rank.

20. The method according to claim 19, wherein said initial rank is updated based on the analysis of the relationship between said one or more random data points and said first data range and said at least one additional data range within said set.

21. A computer-readable medium encoding a computer program of instructions for executing a computer process for analyzing a set of two or more data ranges, said computer process comprising:
(a) selecting a first data range from said set;
(b) selecting at least one additional data range from said set;
(c) analyzing the relationship between said first data range and said at least one additional data range; and
(d) ranking said first data range and said at least one additional data range within said set.

22. The computer-readable medium according to claim 21, further comprising:
generating a representative data range based on the ranking of said first data range and said at least one additional data range.

23. The computer-readable medium according to claim 22, wherein said representative data range is an overlapping data range determined from the relationship between said first data range and said at least one additional data range.

24. The computer-readable medium according to claim 21, further comprising:
generating an optimal data point based on the ranking of said first data range and said at least one additional data range.

25. The computer-readable medium according to claim 21, where the computer process of (b), (c) and (d) is performed iteratively.

26. The computer-readable medium according to claim 21, further comprising a weighting constant for each of said one or more dimensions to adjust the ranking of said first data range and said at least one additional data range.

27. The computer-readable medium according to claim 21, wherein each of said first data range and at least one additional data range are assigned an initial rank.

28. The computer-readable medium according to claim 21, wherein said first data range and said at least one additional data range include at least one dimension and one or more data values.

29. A computer-readable medium encoding a computer program of instructions for executing a computer process for analyzing a set of two or more data ranges, said computer process comprising:
(a) selecting one or more random data points with said set;
(b) analyzing the relationship between said one or more random data points and said two or more data ranges, wherein said two or more data ranges comprise a first data range and at least one additional data range within; and
(c) ranking said one or more random data points based on the relationship with said first data range and said at least one additional data range within said set.
